(19) United States
(12) Patent Application Publication
(10) Pub. No.: US 2008/0142509 A1
(43) Pub. Date: Jun. 19, 2008

(54) Food cooking/warming appliance

(76) Inventor: Eddie Man-Ying Chan, Kowloon (CN)

Correspondence Address: ALIX YALE & RISTAS LLP, 750 MAIN STREET, SUITE 1400, HARTFORD, CT, 06103, US

(21) Appl. No.: 11/638,987

(22) Filed: Dec. 14, 2006

(51) Int. Cl. H05B 1/02

(52) U.S. Cl. 219/490

(57) ABSTRACT

A food cooking/warming appliance includes a housing, a top panel covering the housing and having an aperture, a shroud depending from the top panel through the aperture, a food vessel located within the shroud, a heating element located within the housing beneath the shroud, and control knob for controlling energy to the heating element.

### BACKGROUND OF THE INVENTION

The present invention relates to food cooker/warmers. The invention more particularly, although not exclusively, relates to a domestic food cooking and warming appliance.

Known food cookers/warmers comprise a heated receptacle for food that is covered by a lid which is raised to reveal food for serving.

### OBJECTS OF THE INVENTION

It is an object of the present invention to provide a food cooking/warming appliance in which individual components of the appliance can be readily disassembled for cleaning and/or maintenance purposes.

### DISCLOSURE OF THE INVENTION

There is disclosed herein a food cooking/warming appliance, comprising:
a housing,
a detachable top panel covering the housing and having an aperture,
a detachable shroud depending from the top panel through the aperture,
a food vessel located within the shroud,
a heating element located within the housing beneath the shroud, and
means for controlling energy to the heating element.

Preferably, the housing comprises a base panel and further comprising a frame resting upon the base panel and supporting the top panel.

Preferably, the base panel comprises an aperture covered by an access cover.

Preferably, the heating element is supported by a heating element tray.

The food cooker/warmer can further comprise an installation plate beneath the heating element tray.

Preferably, a plurality of said shrouds, vessels and heating elements are situated side-by-side.

Preferably, the means for controlling energy to the heating element comprises a control knob upon a front panel of the housing.

Preferably, the frame comprises an aperture through which electrical cabling can pass.

### BRIEF DESCRIPTION OF THE DRAWINGS

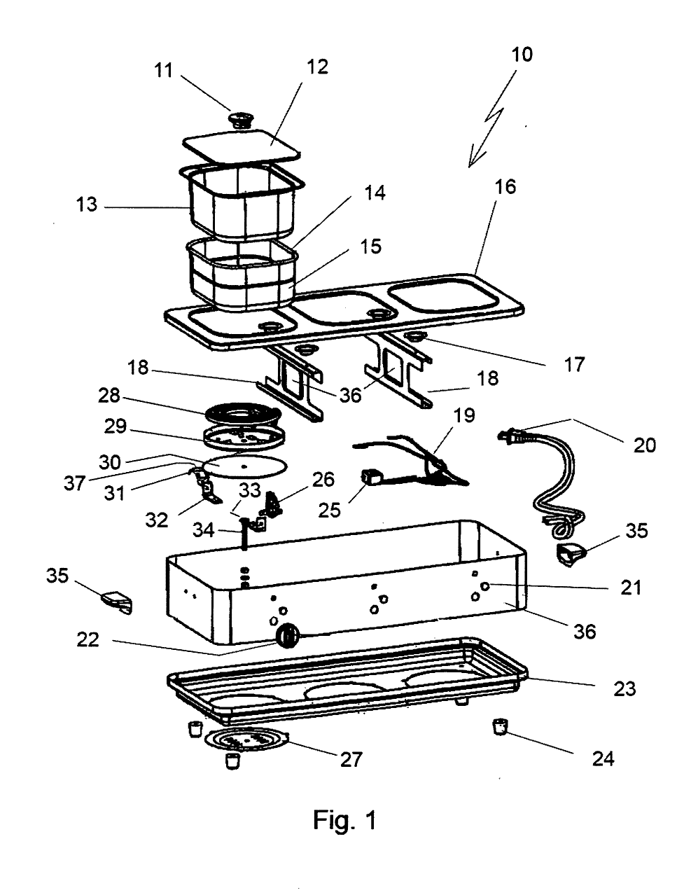

A preferred form of the present invention will now be described by way of example with reference to FIG. 1 which is a schematic parts-exploded perspective illustration of a food cooking/warming appliance.

### DESCRIPTION OF THE PREFERRED EMBODIMENT

In the accompanying drawing there is depicted schematically a food cooking/warming appliance 10. The appliance includes a housing 36 typically of stainless steel or like material having a front panel 21 with control knobs 22 thereon. The housing includes a pair of handles 35—one at each end and by which the appliance can be carried from place to place. Covering the housing is a top panel 16. The top panel 16 simply rests in place upon the housing 36 without fixing screws, rivets or the like so as to be easily raised off the housing 36. The top panel 16 has a number of apertures through which aluminium shrouds extend. The shrouds are not fixed to the top cover, but simply depend there from and are readily removed without tools. Each shroud comprises a wall 14 and a base 15 removably secured to the wall 14.

Located within each shroud is a food vessel 13 covered by a lid 12 having a handle 11.

The housing includes a base panel 23 having a number of openings therein—each closed by an access cover 27. The base panel 23 is fixed to the housing 36. The base panel 23 includes feet 24 which might be of rubber. Resting upon the base panel 23 is a pair of support frames 18 each having an aperture 36. A number of mountings 17 are fixed upon each frame 18 for supporting the top panel 16. The mountings are not fixed to the top panel 16.

The heating element 28 is positioned beneath the shroud 14, 15 and rests upon a heating element tray 29. A fixation 31 and fuse 37 is provided for each heating element 28. Electrical connectors 32 and 33 are also provided at each heating element. A drain 34 depends from each support tray 29. An insulation disc 30 typically of mica is located beneath each heating element tray 29 as a barrier for heat from the heating element which might otherwise radiate downwardly through access cover 27 to a benchtop upon which the appliance rests in use.

A wiring harness 19 for connection to a power cord 20 extends through the apertures 36 of the frames 18 and comprises a porcelain terminal block 25 for electrical connection. The wiring harness 19 extends to each of the heating element connectors 32 and 33 and a temperature control switch 26 associated with each control knob 22.

The parts illustrated in the figure can be readily assembled and carried to a place of use. The power cord can be plugged into a wall socket and pre-prepared food within vessel 13 can be lowered into the aluminium shrouds for reheating/warming. Alternatively, uncooked food can be cooked in the appliance. The control knobs 22 can be activated to maintain the temperature of the food, or raised to a higher temperature setting for cooking purposes. Cleaning can be readily achieved by simple disassembly of the shrouds from the top panel, and removal of the top panel from the housing.

It should be appreciated that modifications and alterations obvious to those skilled in the art are not be considered as beyond the scope of the present invention. For example, the access covers 27 might be provided in the back of the housing, rather than in the base panel. Also, rather than providing electrical heating, gas burners might be provided.

1. A food cooking/warming appliance, comprising:
a housing,
a detachable top panel covering the housing and having an aperture,
a detachable shroud depending from the top panel through the aperture,
a food vessel located within the shroud,
a heating element located within the housing beneath the shroud, and
means for controlling energy to the heating element.

2. The appliance of claim 1, wherein the housing comprises a base panel and further comprising a frame resting upon the base panel and supporting the top panel.

3. The appliance of claim 1, wherein the base panel comprises an aperture covered by an access cover.

4. The appliance of claim 1, wherein the heating element is supported by a heating element tray.

5. The appliance of claim 4, further comprising an installation plate beneath the heating element tray.

6. The appliance of claim 1, comprising a plurality of said shrouds, vessels and heating elements situated side-by-side.

7. The appliance of claim 1, wherein said means for controlling energy to the heating element comprises a control knob upon a front panel of the housing.

8. The appliance of claim 2, wherein the frame comprises an aperture through which electrical cabling can pass.
